(19) United States
(12) Patent Application Publication
(10) Pub. No.: US 2026/0202337 A1
(43) Pub. Date: Jul. 16, 2026

(54) FUSION OPTICAL MEASUREMENT DEVICE

(71) Applicant: KOREA RESEARCH INSTITUTE OF STANDARDS AND SCIENCE, Daejeon (KR)

(72) Inventors: Yong Jai CHO, Daejeon (KR); Hyuksang Kwon, Sejong-si (KR); CHEGAL Won, Daejeon (KR)

(21) Appl. No.: 19/362,583

(22) Filed: Oct. 20, 2025

(30) Foreign Application Priority Data
Jan. 10, 2025 (KR) 10-2025-0003870

(51) Int. Cl. G01N 21/65; G01N 21/21; G01N 21/47

(52) U.S. Cl. CPC G01N 21/65; G01N 21/211; G01N 21/47; G01N 2021/4792

(57) ABSTRACT

An embodiment relates to a fusion optical measurement device that quickly and accurately measures a sample while compensating for measurement errors in microstructural dimensions of an ellipsometer by converting material property information and optical constant information of a sample obtained from a Raman device and an ellipsometer into big data.

### CROSS REFERENCE TO RELATED APPLICATIONS

This application claims priority from Korean Patent Application No. 10-2025-0003870, filed on Jan. 10, 2025, in the Korean Intellectual Property Office, which is incorporated herein by reference in its entirety.

### BACKGROUND

The disclosure relates to a fusion optical measurement device, and more particularly, to a fusion optical measurement device that quickly and accurately measures a sample while compensating for measurement errors in microstructural dimensions of an ellipsometer by converting material property information and optical constant information of a sample obtained from a material property measurement device such as a Raman and an optical property measurement device such as an ellipsometer into big data.

Automated ellipsometry was first made possible by researchers like Aspnes in 1975, and since then, measurement times have been significantly reduced and precision has been significantly improved. Furthermore, spectroscopic ellipsometry, which measures the target object using multiple wavelengths, has also become commercially available. Ellipsometry offers the advantage of non-destructive optical measurement of samples with microstructures, such as thin film layer thickness and nanopattern shape, allowing for high-precision determination of structural dimensions such as thin film layer thickness, nanopattern shape, interfacial layer thickness, and surface roughness, as well as the complex refractive index and optical constants of the complex dielectric function for constituent substances; therefore, this has led to its widespread use in semiconductor manufacturing processes. Even now, it is being used as an Optical Critical Dimension (OCD) measurement device to measure the structural dimension of the circuit pattern on the wafer whose line width is less than 10 nm, and is being used in a complementary form with Critical Dimension-Scanning Electron-beam Microscope (CD-SEM), CD-Atomic Force Microscope (AFM), or Transmission Electron Microscope (TEM).

Recently, semiconductor circuit designs have become more complex than before, with advancements in three-dimensional architectures, such as Gate-All-Around (GAA) logic semiconductor devices, 3D-DRAM (Dynamic Random-Access Memory), and Vertical-NAND (Negative-AND) flash memory. Many OCD measurement devices utilize spectroscopic ellipsometry as their measurement principle. In order to obtain the measured semiconductor circuit structural dimensions (thin film layer thickness, nanopattern shape, interfacial layer thickness, surface roughness, etc.) or the optical constants (complex refractive index and complex dielectric constant) of the constituent substance, OCD measurement equipment employs a method, which involves creating an analytical model for the measurand, which uses the structural dimensions or optical constants as floating parameters, and fitting the model to the measured values of the measurand to obtain answers for the floating parameters (i.e., semiconductor circuit structural dimensions or optical constants of the constituent substance). As the structure of the object being sought becomes more complex, the number of floating parameters increases. For example, current FinFET OCD measurements require more than 10 floating parameters, and the number of floating parameters is expected to increase further with the next-generation GAA architecture. Ellipsometry typically measures two values of the ellipsometric angles (i.e., Ψ and Δ), one of a set of measurands; however, these angles (i.e., Ψ and Δ) are wavelength-dependent. Therefore, in spectroscopic ellipsometry, the ellipsometric angles (Ψ and Δ) can be expressed as ΨλΔλ.

An ellipsometer using ellipsometry projects a measurement beam onto the sample surface with a cross-sectional area of ~10 um×~10 μm or ~1 mm×~1 mm; therefore, the measured structural dimensions and constituent substance optical constants are given as ensemble average values within the cross-sectional area.

The optical constants of the constituent substances in a sample can vary depending on the material properties of the constituent substances (composition ratio, crystallinity, stress variation, impurities and contaminants, temperature, etc.).

Accordingly, since the ellipsometer generally measures the average value of the cross-sectional area of the measuring beam irradiated on the sample, there is a problem in that it is difficult to determine the homogeneity of the structural dimensions and optical constants within the cross-sectional area of the measuring beam.

The ellipsometer has been problematic in that the analytical model for samples with fine structural dimensions of 10 nm or less has a strong mathematical interdependence between the structural dimensions and the optical constants of the constituent substances, which causes ellipsometry fitting results to be slow to converge and may vary with each fitting attempt, and this results in relatively long analysis times and reduced accuracy.

For example, when multiple samples manufactured using the same process equipment exhibit subtle differences in material properties due to process control issues, resulting in different optical constants of the constituent substances, the ellipsometer can misrepresent the structural dimensions in the analytical results.

One solution to the above-mentioned strong interdependent characteristic problem is to first determine the structural numerical information of the sample using measuring equipment capable of measuring structural numerical values, such as CD-SEM, CD-AFM, and TEM, and then use the determined structural numerical information to establish an ellipsometer analysis model that uses only optical constants as plotting variables, and fit it to the ellipsometer measurement data to determine the optical constant information of the slightly changed constituent substance, so that the new optical constant information is stored as new reference data along with material property information, and can be selected and used later when necessary.

Therefore, in semiconductor device manufacturing processes, to obtain structural dimension information for numerous nanostructure samples manufactured using ellipsometers, existing reference data on the optical constants of constituent substances (e.g., reference standard values, data provided by measuring equipment companies, previously obtained data, or data recorded in reference literature) are used, and by adopting a simplified analysis model that sets only structural dimensions as plotting parameters, analysis time for measured data is minimized.

However, when using this simplified analysis model, even subtle differences in material properties between samples can be misinterpreted as changes in structural dimensions, which are the results of the measured quantity analysis. Thus, continuous measurement is necessary to assess the material property information of constituent substances using measuring equipment specifically designed for material property evaluation, such as Raman.

In industrial settings using ellipsometers, minimizing measurement time is crucial, as increasing hourly production throughput is crucial, and improving manufacturing yields to reduce production costs is increasingly crucial, making improving measurement accuracy increasingly crucial.
(Patent Document 1) Republic of Korea Publication No. 10-2022-0004544 (Jan. 11, 2022)

### SUMMARY

An aspect of the disclosure is to provide a fusion optical measurement device that can shorten the measurement time and improve the measurement accuracy by obtaining measurement data of a sample for the same area of the sample by an ellipsometer and a Raman device, respectively, and determining the optical constant information of the constituent substance using an ellipsometer analysis model that plots only the optical constants of the constituent substance as a plotting parameter depending on whether there is a change in the material property information of the constituent substance of the sample obtained by analyzing the Raman measurement data, or by selecting one of the reference data of optical constants suitable for the constituent substance and using an ellipsometer analysis model that plots only the structural dimension as a plotting variable to determine the optimal structural dimension information of the sample.

The aspect of the disclosure is not limited to that mentioned above, and other aspects not mentioned will be clearly understood by those skilled in the art from the description below.

The disclosure provides a fusion optical measurement device, including: a Raman device that irradiates a sample with first incident light and acquires material property information of a constituent substance of the sample from Raman measurement data of the sample based on a scattered light image of scattered light scattered from the sample; an ellipsometer that irradiates the sample with second incident light and acquires structural dimension information of the sample and optical constant information of the constituent substance from ellipsometer measurement data detected by a change in the polarization state of reflected light reflected from the sample; and an artificial intelligence part that determines optical constant information of the constituent substance by using one of a plurality of ellipsometer optical analysis models that use only the optical constant of the constituent substance as a plotting variable according to a change in the material property information transmitted from the Raman device, or determines optimal structural dimension information of the sample by using one of a plurality of ellipsometer structural analysis models that use only the structural dimension as a plotting parameter by selecting reference data of optical constants suitable for the constituent substance.

In an embodiment of the disclosure, the artificial intelligence part may include a determination part that receives the ellipsometer measurement data transmitted from the ellipsometer, the structural dimension information, the optical constant information, the Raman measurement data transmitted from the Raman device, and the material property information, and determines whether there is a change in the material property information of the constituent substance.

In an embodiment of the disclosure, the artificial intelligence part may include: a structural dimension determination part that determines the structural dimension information using structural dimension measurement equipment when the determination part determines that there is a change in the material property information or when the material property information is received for the first time; an optical constant fitting part that selects one of the plurality of ellipsometer optical analysis models using the determined structural dimension information and then fits the selected one of the ellipsometer optical analysis models to the ellipsometer measurement data to determine the optical constant information; a reference data storage part that stores the optical constant information along with the material property information as reference data; a selection part that selects reference data for optical constants appropriate for the constituent substance based on the material property information transmitted from the determination part and selects one of the plurality of ellipsometer structural analysis models; a fitting part that determines the structural dimension information of the sample by fitting the structural dimension information transmitted from the selection part to the selected one of the ellipsometer structural analysis models; and a big data part storing the Raman measurement data, the ellipsometer measurement data, the optical constant information, the material property information transmitted from the selection part, and the structural dimension information transmitted from the fitting part.

In an embodiment of the disclosure, the structural dimension information may include the sample's thin film layer thickness, nanopattern shape, interface layer thickness, and surface roughness, the optical constant information includes the sample's complex refractive index and complex dielectric constant, the determination part may select the optical constant information for one matched piece of the material property information when the material property information matches with one piece of measurement position-specific material property information of the sample, and the fitting part may use the optical constant information selected as reference information to select one of the plurality of ellipsometer structural analysis models, and then fit the selected one of the ellipsometer structural analysis models to the ellipsometer measurement data to determine the sample's structural dimension information.

In an embodiment of the disclosure, the Raman device may include: a first light irradiation part that generates the first incident light by magnifying the magnitude of irradiation light after generating the irradiation light; a beam splitter part arranged on the path of the first incident light, reflecting the first incident light incident from the first light irradiation part toward the sample, and transmitting scattered light scattered from the sample; a light collection part arranged in the same straight line as the sample and the beam splitter part and collecting the first incident light reflected from the beam splitter part onto the sample; a wavelength selective filter part arranged on the path of the scattered light and selectively transmitting Stokes scattered light and anti-Stokes scattered light among the scattered light transmitted from the beam splitter part; a first detection part that is arranged on the path of the scattered light and obtains a Stokes scattered light image and an anti-Stokes scattered light image from signals for Stokes scattered light and anti-Stokes scattered light selectively transmitted through the wavelength selective filter part; and a first analysis part that analyzes the temperature distribution of the sample based on the Stokes scattered light image and the anti-Stokes scattered light image transmitted from the first detection part, and analyzes the composition distribution of the sample based on the Stokes scattered light image.

In an embodiment of the disclosure, the first analysis part may analyze the temperature distribution of the sample based on the signal magnitude ratio of the intensity of the Stokes scattered light and the intensity of the anti-Stokes scattered light obtained from a Stokes scattered image and anti-Stokes image selectively transmitted from the wavelength selective filter part.

In an embodiment of the disclosure, the first analysis part may analyze the composition distribution of the sample by analyzing the brightness of the Stokes scattered image selectively transmitted from the wavelength selective filter part.

In an embodiment of the disclosure, the Raman device may further include a polarization direction adjustment part that is arranged in the same straight line as the sample and the beam splitter part and rotates to adjust the polarization direction of the first incident light reflected from the beam splitter part and the polarization direction of the scattered light.

In an embodiment of the disclosure, the first analysis part may obtain a peak area where the signal of the scattered light image for each rotation angle in which the polarization direction of the scattered light is adjusted is a peak, and analyze the strain distribution for each position of the sample by superimposing the magnitude of the signal of the scattered light image for each rotation angle in which the polarization direction of the scattered light is adjusted on polar coordinates.

In an embodiment of the disclosure, the first light irradiation part may include: a first light source that generates the irradiation light and irradiates it toward the beam splitter part; a line filter that is arranged on the path of the irradiation light and transmits only the irradiation light having a first predetermined wavelength band among the irradiation light incident from the light source; and a magnifying lens that is arranged on the path of the irradiation light and enlarges the magnitude of the irradiation light having the first predetermined wavelength band transmitted by the line filter to generate the first incident light.

In an embodiment of the disclosure, the beam splitter part may reflect 10% to 30% of the first incident light incident from the first light irradiation part to the sample, and transmit 70% to 90% of the scattered light scattered from the sample.

In an embodiment of the disclosure, the ellipsometer may include: a second light irradiation part that generates the second incident light and irradiates it to the sample; a polarization generation part that polarizes the second incident light transmitted from the second light irradiation part; a polarization analysis part that polarizes the reflected light reflected after the second incident light polarized by the polarization generation part is irradiated to the sample; a second detection part that detects the electrical signal of the reflected light polarized by the polarization analysis part; and a second analysis part that analyzes the electrical signal of the reflected light detected by the second detection part to obtain structural dimension information of the sample and optical constant information of the constituent substance.

The effect of the disclosure is that the ellipsometer and the Raman device obtain the structural dimension information and material property information of the sample for the same area of the sample, respectively, and determine the optimal structural dimension information of the sample by applying the analysis model of the sample depending on whether the material property information changes, thereby shortening the measurement time and improving the measurement accuracy.

The effects of the disclosure are not limited to the effects described above, and should be understood to include all effects that are inferable from the configuration of the disclosure described in the detailed description or claims of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a conceptual view illustrating a fusion optical measurement device according to an embodiment of the disclosure;

FIG. 2 is a block diagram illustrating a fusion optical measurement device according to an embodiment of the disclosure; and

FIG. 3 is a flowchart illustrating an operation process of an artificial intelligence component included in a fusion optical measurement device according to an embodiment of the disclosure.

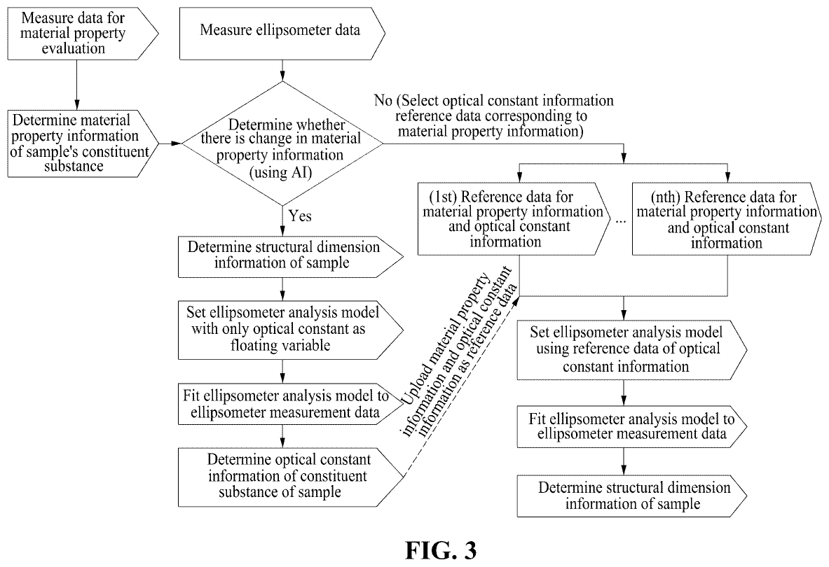

### DETAILED DESCRIPTION

Hereinafter, the disclosure will be described with reference to the accompanying drawings. However, the disclosure may be implemented in various different forms and therefore is not limited to the embodiments described herein. In addition, in order to clearly describe the disclosure in the drawings, parts that are not related to the description are omitted, and similar parts are given similar drawing reference numerals throughout the specification.

In the entire specification, when a part is said to be “connected (linked, contacted, coupled)” to another part, this includes not only the case where it is “directly connected” but also the case where it is “indirectly connected” with another member in between. In addition, when a part is said to “include” a component, this does not mean that it excludes other components, unless otherwise specifically stated, but rather that it may include other components.

The terms used in this specification are used only to describe specific embodiments and are not intended to limit the disclosure. The singular expression includes the plural expression unless the context clearly indicates otherwise. In this specification, the terms “include” or “have” are intended to specify the presence of a feature, number, step, operation, component, part, or combination thereof described in the specification, but should be understood as not excluding in advance the possibility of the presence or addition of one or more other features, numbers, steps, operations, components, parts, or combinations thereof.

Hereinafter, embodiments of the disclosure will be described in detail with reference to the accompanying drawings.

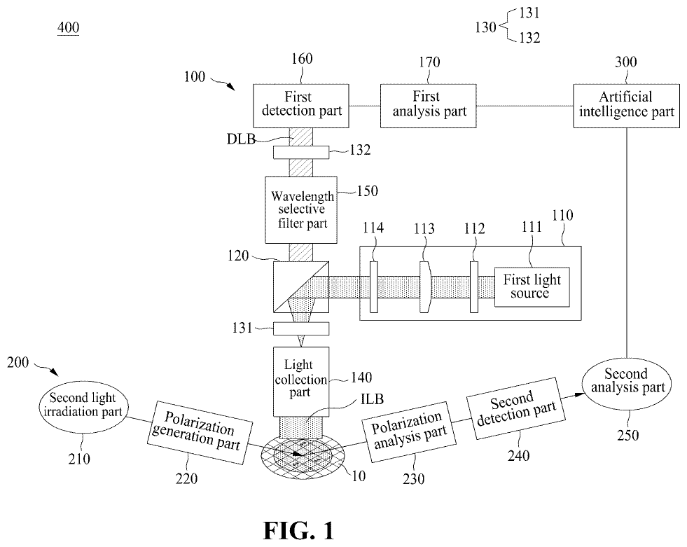

FIG. 1 is a conceptual view illustrating a fusion optical measurement device according to an embodiment of the disclosure.

Referring to FIG. 1, a fusion optical measurement device (300) according to one embodiment of the disclosure includes a Raman device (100), an ellipsometer (200), and an artificial intelligence part (300).

The Raman device (100) irradiates a sample (10) with a first incident light beam and acquires material property information of constituent substances of the sample (10) from Raman measurement data based on the scattered light image of the scattered light scattered from the sample (10).

The Raman device (100) in the disclosure is preferably a hyperspectral Raman device, but may also be used as a confocal Raman device.

The Raman device (100) includes a first light irradiation part (110), a beam splitter part (120), a polarization direction adjustment part (130), a light collection part (140), a wavelength selective filter part (150), a first detection part (160), and a first analysis part (170).

Here, the material property information of the sample (10) includes parameter values for the symmetry, orientation, strain distribution, and composition distribution of the sample (10).

The first light irradiation part (110) generates irradiation light and then generates a first incident light that magnifies the irradiation light.

Referring to FIG. 1, the first light irradiation part (110) includes a first light source (111), a line filter (112), a magnifying lens (113), and a fixed polarizer (114).

The first light source (111) generates irradiation light and irradiates it toward the beam splitter part (120).

In the disclosure, the first light source (111) is described as a laser that irradiates a laser beam, which is irradiation light, but is not limited thereto.

For example, the first light source (111) may be a white light source that irradiates white light.

The line filter (112) is positioned along the irradiation light path and transmits only the irradiation light having a predetermined first wavelength band from the first light source (111).

Specifically, the line filter (112) is preferably a laser line filter or a laser clean-up filter that blocks background radiation and plasma light from the laser.

Furthermore, the line filter (112) is positioned along the same line as the first light source (111) and the magnifying lens (113), and is positioned between the first light source (111) and the magnifying lens (113).

The magnifying lens (113) is positioned along the irradiation light path and magnifies the irradiation light having a predetermined first wavelength band transmitted by the line filter (112), thereby generating the first incident light.

For example, the magnifying lens (113) may include a reflective beam-magnifying spherical mirror.

Specifically, the magnifying lens (113) is arranged collinearly with the first light source (111) and the line filter (112), and is preferably positioned between the first light source (111) and the line filter (112).

Furthermore, the magnifying lens (113) is formed as follows to magnify the magnitude of the irradiation light that has passed through a relatively narrow band through the line filter (112).

Specifically, one surface of the magnifying lens (113), facing the line filter (112), is formed convexly toward the line filter (112).

On the other hand, the other surface of the magnifying lens (113), facing the beam splitter part (120), is formed as a plane perpendicular to the irradiation light.

Meanwhile, the magnifying lens (113) may include two spherical reflective mirrors with different foci.

Even when two spherical reflective mirrors with different foci are used, the same principle applies, as the magnitude of the laser beam can be magnified. This has the advantage of being applicable to a wide range of wavelengths.

The fixed polarizer (114) linearly polarizes the first incident light magnified by the magnifying lens (113).

Furthermore, the fixed polarizer (114) is arranged collinearly with the first light source (111), line filter (112), and magnifying lens (113), and is positioned between the magnifying lens (113) and the beam splitter part (120).

The fixed polarizer (114) passes the linearly polarized first incident light through the beam splitter part (120).

However, if the inherent linear polarization of the laser is high (100:1 or higher), the fixed polarizer (114) described above can be omitted.

The beam splitter part (120) is positioned along the path of the first incident light, reflects the first incident light from the first light irradiation part (110) toward the sample, and transmits the scattered light scattered from the sample (10).

Additionally, the beam splitter part (120) reflects 10% to 30% of the incident light incident from the light irradiation part (110) onto the sample (10) and transmits 70% to 90% of the scattered light scattered from the sample (10) to analyze the temperature distribution and composition distribution of the sample (10).

Specifically, the beam splitter part (120) varies the ratio of reflection (R) and transmission (T) to collect the intensity of the incident light (=laser beam) irradiated onto the sample (10) and the signal scattered from the sample (10).

For example, when the power of the light source (111) is sufficiently high, the beam splitter part (120) reflects 10% of the incident light to irradiate the sample (10), and allows 90% of the scattered light scattered from the sample (10) to be transmitted. In this case, a sufficient Raman signal can be obtained.

On the other hand, when the power of the incident light (=laser beam) is insufficient, the beam splitter part (120) reflects 30% of the incident light to irradiate the sample (10), and allows 70% of the scattered light scattered from the sample (10) to be transmitted. However, in this case, the intensity of the scattered Raman signal decreases, requiring a longer measurement time.

The beam splitter part (120) for this purpose is aligned with the first light source (111), line filter (112), magnifying lens (113), and fixed polarizer (114), as well as the light collection part (140), wavelength-selective filter part (150), and first detection part (160).

That is, the beam splitter part (120) is positioned at the intersection of the path of the first incident light passing through the first light source (111), line filter (112), magnifying lens (113), and fixed polarizer (114) and the path of the scattered light scattered from the sample (10) and passing through the first detection part (160).

First, the beam splitter part (120) reflects the linearly polarized first incident light toward the sample (10).

Here, the scattered light, whose polarization direction is adjusted by the first half-wave plate (131), includes Stokes scattered light and anti-Stokes scattered light.

In particular, the beam splitter part (120) transmits Stokes and anti-Stokes scattered light, whose polarization direction has been adjusted by the first half-wave plate (131); after irradiating the specimen with a magnifying light, the Stokes and anti-Stokes scattered light generated from the specimen appears over a wide area of the light irradiation, and the changes can be observed by changing the polarization direction. The resulting polarization direction change can be varied from 1° to 90°. If a specific Raman band region of the Stokes scattered light, which varies by 10°, is selectively imaged through the wavelength-selective filter part (150), a total of 36 images are obtained, and these images can be used to understand the symmetry, orientation, and strain of a local area after 3D stacking by varying the angles in the X and Y planes. More simply, linearity can be verified using the Stokes vector relationship, as shown below.

As shown in formula 1 below, four X and Y images are acquired, representing the spectral irradiance values E₀, E₄₅, E₉₀, and E₁₃₅, measured by pixels with different polarization directions of 0°, 45°, 90°, and 135°. From these image measurements, the X and Y images S₀, S₁, and S₂ are calculated, respectively. The calculated values for S₀, S₁, and S₂ include optical characteristics related to the measurement system, such as the spectral flux of the light source, the quantum efficiency and pixel area of the photodetector, the reflectivity and transmittance of the beam splitter, and the transmittance of the fixed polarizer and first half-wave plate, and thus to eliminate or minimize this effect, physical quantities defined as fractions of the calculated values for S₀, S₁, and S₂ can be used, as shown below. In this way, the degree of linear polarization (DoLP) can be obtained from formula 2, and formula 3 can be used to determine the direction in which the polarization component is most prominent.

$$\vec{S} = [ \begin{matrix}{S}_{0} \\ {S}_{1} \\ {S}_{2} \\ {S}_{3}\end{matrix} ] = [ \begin{matrix}{E}_{0} + {E}_{90} \\ {E}_{0} - {E}_{90} \\ {E}_{45} - {E}_{135} \\ {E}_{R} - EL\end{matrix} ] \qquad [ Formula 1 ]$$

$$DoLP = \frac{\sqrt{{S}_{1}^{2} + {S}_{2}^{2}}}{{S}_{0}} \qquad [ Formula 2 ]$$

$$Orientation = \frac{1}{2} {tan}^{- 1} \frac{{S}_{2}}{{S}_{1}} \qquad [ Formula 3 ]$$

Using formulas 2 and 3, X and Y images can be obtained, respectively, based on the degree of linear polarization and polarization direction from the X and Y images of S₀, S₁, and S₂.

Likewise, the degree of linear polarization can be determined through the Stokes vectors, which can be used to quickly identify the presence or absence of deformation.

The polarization direction adjustment part (130) is positioned collinearly with the sample (10) and the beam splitter part (120) and rotates to adjust the polarization direction (PD) of the incident light reflected from the beam splitter part (120) and the polarization direction (PD) of the scattered light.

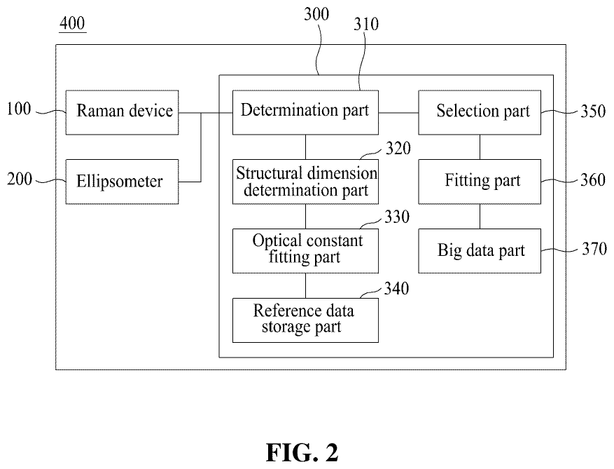

(a) and (b) of FIG. 2 are exploded perspective views showing images of scattered light at different rotation angles, respectively, with the polarization directions of the incident and scattered light adjusted, in a hyperspectral Raman device for structural analysis of a sample according to one embodiment of the disclosure.

Additionally, the first rotation angle between the reference line and the first polarization direction (PD1) is 0°, the angle between the reference line and the second polarization direction (PD2) is 45°, the angle between the reference line and the third polarization direction (PD3) is 90°, and the angle between the reference line and the fourth polarization direction (PD4) is 135°.

Additionally, the disclosure describes that the symmetry, orientation, and strain distribution of the sample (10) can be determined by setting only four rotation angles; however, a smaller rotation angle can improve the accuracy of the symmetry, orientation, and strain distribution of the sample (10).

Considering the above, it is preferable to set the rotation angle considering the time required to analyze the symmetry, orientation, and strain distribution of the sample (10) and the accuracy of the symmetry, orientation, and strain distribution of the sample (10).

The polarization direction adjustment part (130) for this purpose includes a first half-wave plate (131) and a second half-wave plate (132).

The first half-wave plate (131) rotates at a preset angle to change the polarization direction of the incident light reflected from the beam splitter part.

Additionally, the first half-wave plate (131) is aligned with the beam splitter part (120) and the light collection part (140), and is positioned therebetween.

The second half-wave plate (132) rotates at a preset rotation angle to selectively transmit scattered light transmitted by the wavelength-selective filter part (150) to the detector (160).

Additionally, the second half-wave plate (132) is aligned with the wavelength-selective filter part (150) and the detector (160), and is positioned between them.

The first and second half-wave plates (131, 132) described above rotate together at the same preset rotation angle so that the polarization direction of the incident light passing through the first half-wave plate (131) and the polarization direction of the scattered light passing through the second half-wave plate (132) are identical.

Additionally, if the analysis unit (170) determines that the scattered light passing through the wavelength-selective filter part (150) is distorted, the second half-wave plate (132) rotates clockwise or counterclockwise based on the preset rotation angle to correct the distortion of the scattered light passing through the wavelength-selective filter part (150).

The polarization direction adjustment part (130) described above uses the first and second half-wave plates (131, 132) to adjust the polarization direction, but a quarter-wave plate can also be used.

Specifically, after generating rotational polarization using a quarter-wave plate, the direction of polarization irradiated to the sample (10) may be varied by rotating the fixed polarizer (114), and an optical phase delay unit may also be used to perform the same function.

Meanwhile, linearly polarized light can be irradiated to the sample (10) through the fixed polarizer (114) and polarized Raman measurements can be performed while rotating the sample (10) 360 degrees.

Accordingly, the scattered light scattered from the sample (10) and passing through the light collection part (140) passes through the beam splitter part (120) without its polarization direction being adjusted by the first half-wave plate (131), and the scattered light (=Stokes scattered light and anti-Stokes scattered light) passing through the wavelength selective filter part also has its polarization direction not adjusted by the second half-wave plate (132).

In addition to analyzing the strain distribution of the sample (10) described above, if the composition distribution and composition ratio of the sample (10) are also analyzed, the polarization direction adjustment part (130) is terminated.

The light collection part (140) is arranged in the same straight line as the sample (10) and the beam splitter part (120) and focuses the first incident light reflected from the beam splitter part (120) onto the sample (10).

For example, the light collection part (140) may be an objective lens.

The wavelength selective filter part (150) is arranged in the path of scattered light to selectively transmit Stokes scattered light and anti-Stokes scattered light among the scattered light transmitted from the beam splitter part (120) to analyze the strain distribution and composition distribution of the sample (10).

Specifically, the wavelength-selective filter part (150) selectively transmits only scattered light having a second wavelength band from the beam splitter part (120).

Here, the scattered light having a second wavelength band includes Stokes scattered light and anti-Stokes scattered light.

The wavelength-selective filter part (150) for this purpose may be any of a tunable filter (TF), a liquid crystal tunable filter (LCTF), an acousto-optic wavelength tunable filter (AOTF), a band-pass filter (BF), or a filter that transmits only a specific polarization direction, manufactured by combining two edge filters with different incidence angles.

However, the scattered light having a second wavelength band transmitted by the wavelength-selective filter part (150) may include Rayleigh scattering.

Accordingly, the disclosure may further include a notch filter (not shown) positioned between the wavelength-selective filter part (150) and the first detection part (160) to remove Rayleigh scattering from the Stokes scattered light and anti-Stokes scattered light selectively transmitted through the wavelength-selective filter part (150).

The first detection part (160) is positioned along the path of scattered light and acquires a Stokes scattered light image and an anti-Stokes scattered light image from the signals for the Stokes scattered light and anti-Stokes scattered light selectively transmitted through the wavelength-selective filter part (150).

In particular, the first detection part (160) is positioned along the path of scattered light and acquires a scattered light image (SLI) from the signals for the scattered light transmitted through the beam splitter part (120).

The first detection part (160) for this purpose is preferably one of an electron-multiplying charge-coupled device (EM-CCD), a complementary metal-oxide-semiconductor charge-coupled device (CMOS-CCD), a photomultiplier tube (PMT), a silicon photodiode, an indium gallium arsenide photodiode, an ultraviolet photodetector, a visible light photodetector, and an infrared photodetector.

FIG. 2 is a graph showing the intensity of Stokes scattered light and anti-Stokes scattered light according to the Raman shift used to analyze the temperature distribution by a first analysis part of a hyperspectral Raman device for temperature distribution analysis according to an embodiment of the disclosure.

The first analysis part (170) analyzes the temperature distribution of the sample (10) based on the Stokes scattered light image and anti-Stokes scattered light image transmitted from the first detection part (160).

Specifically, referring to FIG. 2, the first analysis part (170) analyzes the temperature distribution

$$( \frac{{I}_{v}^{AS}}{{I}_{v}^{S}} = {A}_{v} \frac{{( {w}_{L} + {w}_{v} )}^{4}}{{( {w}_{L} - {w}_{v} )}^{4}} exp ( \frac{- ℏ {w}_{v}}{{k}_{B} {T}_{v}^{eff}} ) )$$

of the sample (10) based on the signal intensity ratio between the intensity of the Stokes scattered light and the intensity of the anti-Stokes scattered light, obtained from the Stokes scattered image and anti-Stokes image selectively transmitted by the wavelength selective filter part (150).

The signal intensity ratio is defined by mathematical equation 1 below.

$$\frac{{I}_{v}^{AS}}{{I}_{v}^{S}} = {A}_{v} \frac{{( {w}_{L} + {w}_{v} )}^{4}}{{( {w}_{L} - {w}_{v} )}^{4}} exp ( \frac{- ℏ {w}_{v}}{{k}_{B} {T}_{v}^{eff}} ) \qquad [ Mathematical equation 1 ]$$

(Here,

$$\frac{{I}_{v}^{AS}}{{I}_{v}^{S}} = {A}_{v} \frac{{( {w}_{L} + {w}_{v} )}^{4}}{{( {w}_{L} - {w}_{v} )}^{4}} exp ( \frac{- ℏ {w}_{v}}{{k}_{B} {T}_{v}^{eff}} ) :$$

Intensity of anti-Stokes scattered light,

$$\frac{{I}_{v}^{AS}}{{I}_{v}^{S}} = {A}_{v} \frac{{( {w}_{L} + {w}_{v} )}^{4}}{{( {w}_{L} - {w}_{v} )}^{4}} exp ( \frac{- ℏ {w}_{v}}{{k}_{B} {T}_{v}^{eff}} ) :$$

Intensity of Stokes scattered light, Aᵥ: Correction factor related to the signal intensity ratio of the anti-Stokes scattered light signal and the Stokes scattered light signal, w_{L}: Natural frequency of the laser, wᵥ: Frequency of Stokes scattered light and anti-Stokes scattered light, k_{B}: Boltzmann constant (1.380 649×10⁻²³ J/K,

$$\frac{{I}_{v}^{AS}}{{I}_{v}^{S}} = {A}_{v} \frac{{( {w}_{L} + {w}_{v} )}^{4}}{{( {w}_{L} - {w}_{v} )}^{4}} exp ( \frac{- ℏ {w}_{v}}{{k}_{B} {T}_{v}^{eff}} ) :$$

Effective temperature for a specific vibration mode, hwᵥ: Raman displacement) That is, the first analysis part (170) obtains the signal magnitude ratio

$$( \frac{{I}_{v}^{AS}}{{I}_{v}^{S}} = {A}_{v} \frac{{( {w}_{L} + {w}_{v} )}^{4}}{{( {w}_{L} - {w}_{v} )}^{4}} exp ( \frac{- ℏ {w}_{v}}{{k}_{B} {T}_{v}^{eff}} ) / \frac{{I}_{v}^{AS}}{{I}_{v}^{S}} = {A}_{v} \frac{{( {w}_{L} + {w}_{v} )}^{4}}{{( {w}_{L} - {w}_{v} )}^{4}} exp ( \frac{- ℏ {w}_{v}}{{k}_{B} {T}_{v}^{eff}} ) )$$

using mathematical equation 1 above and applies it to mathematical equation 2 below to analyze the temperature distribution

$$( \frac{{I}_{v}^{AS}}{{I}_{v}^{S}} = {A}_{v} \frac{{( {w}_{L} + {w}_{v} )}^{4}}{{( {w}_{L} - {w}_{v} )}^{4}} exp ( \frac{- ℏ {w}_{v}}{{k}_{B} {T}_{v}^{eff}} ) )$$

of the sample (10).

Specifically, the temperature distribution is defined by mathematical equation 2 below.

$${T}_{v}^{eff} = \frac{- ℏ {w}_{v}}{{k}_{B} ln ( \frac{{I}_{v}^{AS}}{{I}_{v}^{S}} \frac{1}{{A}_{v}} \frac{{( {w}_{L} - {w}_{v} )}^{4}}{{( {w}_{L} + {w}_{v} )}^{4}} )} \qquad [ Mathematical equation 2 ]$$

(Here,

$$\frac{{I}_{v}^{AS}}{{I}_{v}^{S}} = {A}_{v} \frac{{( {w}_{L} + {w}_{v} )}^{4}}{{( {w}_{L} - {w}_{v} )}^{4}} exp ( \frac{- ℏ {w}_{v}}{{k}_{B} {T}_{v}^{eff}} ) :$$

Intensity of anti-Stokes scattered light,

$$\frac{{I}_{v}^{AS}}{{I}_{v}^{S}} = {A}_{v} \frac{{( {w}_{L} + {w}_{v} )}^{4}}{{( {w}_{L} - {w}_{v} )}^{4}} exp ( \frac{- ℏ {w}_{v}}{{k}_{B} {T}_{v}^{eff}} ) :$$

Intensity of Stokes scattered light, Aᵥ: Correction factor related to the signal intensity ratio of the anti-Stokes scattered light signal and the Stokes scattered light signal, w_{L}: Natural frequency of the laser, wᵥ: Frequency of Stokes scattered light and anti-Stokes scattered light, k_{B}: Boltzmann constant (1.380 649×10⁻²³ J/K,

$$\frac{{I}_{v}^{AS}}{{I}_{v}^{S}} = {A}_{v} \frac{{( {w}_{L} + {w}_{v} )}^{4}}{{( {w}_{L} - {w}_{v} )}^{4}} exp ( \frac{- ℏ {w}_{v}}{{k}_{B} {T}_{v}^{eff}} ) :$$

Effective temperature for a specific vibration mode, hwᵥ: Raman displacement)

Additionally, the first analysis part (170) analyzes the compositional distribution of the sample (10) based on the Stokes scattered light image transmitted from the detection unit (160).

The first analysis part (170) for this purpose analyzes the brightness of the Stokes scattering image selectively transmitted by the wavelength-selective filter part (150).

Specifically, if the brightness of a specific region in the overall Stokes scattering image is lower than the brightness of the entire region, the first analysis part (170) determines that the sample (10) has at least two types of compositional distributions (Si_{0.9}Ge_{0.1}, Si_{0.8}Ge_{0.2}, Si_{0.7}Ge_{0.3}).

Accordingly, if the brightness of a specific region is lower than the brightness of the entire region, the wavelength-selective filter part (150) adjusts the wavelength and checks the brightness contrast between the overall region and the specific region. By stacking these XY plane images according to each wavelength, three-dimensional information (x, y, μ) can be obtained, and based on this, spectra can be acquired according to x and y positions. The composition ratio of the sample (10) is determined based on the Stokes scattered light spectrum for regions with different brightness contrasts.

The first analysis part (170) for this purpose contains a pre-stored composition ratio data set based on brightness contrasts for each wavelength band of Stokes scattered light.

Meanwhile, the first analysis part (170) determines that the sample (10) is composed of at least one single component if the brightness of a specific region in the entire Stokes scattering image is equal to the brightness of the entire region.

The first analysis part (170) transmits the strain and composition ratio of the sample (10) to the determination part (310) of the artificial intelligence part (300).

The ellipsometer (200) irradiates the sample (10) with a second incident light and acquires structural dimension information of the sample (10) and optical constant information of the constituent substances of the sample (10) from the ellipsometer measurement data detected by the change in polarization state of the reflected light reflected from the sample (10).

Here, the structural dimension information may be parameter values including the thin film layer thickness, nanopattern shape, interfacial layer thickness, and surface roughness of the sample (10), while the optical constant information may be parameter values including the complex refractive index and complex dielectric constant.

The ellipsometer (200) includes a second light irradiation part (210), a polarization generation part (220), a polarization analysis part (230), a second detection part (240), and a second analysis part (250).

The second light irradiation part (210) generates a second incident light and irradiates it onto the sample (10).

The polarization generation part (220) polarizes the second incident light transmitted from the second light irradiation part (210).

The polarization analysis part (230) polarizes the reflected light after the second incident light polarized by the polarization generation part (220) is irradiated onto the sample (10).

The second detection part (240) detects the electrical signal of the reflected light polarized by the polarization analysis part (230).

The second analysis part (250) analyzes the electrical signal of the reflected light detected by the second detection part (240) to obtain structural dimension information of the sample (10) and optical constant information of the constituent substance.

The second analysis part (250) transmits at least one of the structural dimension information of the sample (10) and the optical constant information of the constituent substance to the determination part (310) provided in the artificial intelligence part (300).

The artificial intelligence part (300) determines the optical constant information of the constituent substance (10) using one of several ellipsometer optical analysis models that use only the optical constants of the constituent substance as plotting variables, based on changes in the material property information of the constituent substance transmitted from the Raman device (100). Alternatively, it selects reference data for optical constants appropriate for the constituent substance and uses one of several ellipsometer structural analysis models that use only the structural dimensions as plotting parameters to determine the optimal structural dimension information of the sample (10).

The artificial intelligence part (300) includes a determination part (310), a structural dimension determination part (320), an optical constant fitting part (330), a reference data storage part (340), a selection part (350), a fitting part (360), and a big data part (370).

The determination part (310) receives ellipsometer measurement data, structural dimension information, and optical constant information transmitted from the ellipsometer (200), Raman measurement data transmitted from the Raman device (100), and material property information, and determines whether there is a change in the material property information of the constituent substance.

If the material property information matches any of the material property information at each measurement position of the sample (10), the determination part (310) selects the optical constant information for the matched material property information as the reference information.

Here, the optical constant information may be parameter values including the complex refractive index and complex dielectric constant of the sample (10).

The structural dimension determination part (320) determines structural numerical information using structural dimension measurement equipment if the determination part (310) determines a change in the material property information or receives material property information for the first time.

Here, the structural dimension measurement equipment may be, for example, a CD-SEM, CD-AFM, or TEM.

The optical constant fitting part (330) uses the structural dimension information determined in the structural dimension determination part (320) to select one of multiple ellipsometer optical analysis models, and then fits the selected ellipsometer optical analysis model to the ellipsometer measurement data to determine the optical constant information.

The reference data storage part (340) stores optical constant information along with material property information as reference data.

The selection part (350) selects reference data for optical constants appropriate for the constituent substance based on the material property information transmitted from the determination part (310) and selects one of the multiple ellipsometer structural analysis models.

The fitting part (360) determines the structural dimension information of the sample (10) by fitting the structural dimension information transmitted from the selection part (350) to one of the ellipsometer structural analysis models selected from the selection part (350).

The fitting part (360) uses the optical constant information selected as reference information to select one of the multiple ellipsometer structural analysis models, and then fits the selected ellipsometer structural analysis model to the ellipsometer measurement data to determine the structural dimension information of the sample (10).

The big data part (370) stores structural dimension information, material property information transmitted from the selection part (350), and optical constant information of the sample (10) transmitted from the fitting part (360).

The big data part (370) stores Raman measurement data, ellipsometer measurement data, optical constant information, material property information transmitted from the selection part (350), and structural dimension information transmitted from the fitting part (360).

The description of the disclosure is for illustrative purposes, and those skilled in the art will understand that it can be easily modified into other specific forms without changing the technical idea or essential features of the disclosure. Therefore, the embodiments described above should be understood as being exemplary in all respects and not limiting. For example, each component described as a single type may be implemented in a distributed manner, and likewise, components described as distributed may be implemented in a combined form.

The scope of the disclosure is indicated by the following claims, and all changes or modifications derived from the meaning and scope of the claims and their equivalent concepts should be interpreted as being included in the scope of the disclosure.

### EXPLANATION OF REFERENCE NUMERALS

10: sample
100: Raman device
110: first light irradiation part
111: first light source
112: line filter
113: magnifying lens
114: fixed polarizer
120: beam splitter part
130: polarization direction adjustment part
131: first half-wave plate
132: second half-wave plate
140: light collection part
150: wavelength selective filter part
160: first detection part
170: first analysis part
200: ellipsometer
210: second light irradiation part
220: polarization generation part
230: polarization analysis part
240: second detection part
250: second analysis part
300: artificial intelligence part
310: determination part
320: structural dimension determination part
330: optical constant fitting part
340: reference data storage part
350: selection part
360: fitting part
370: big data part
400: fusion optical measurement device

What is claimed is:

1. A fusion optical measurement device, comprising:
a Raman device configured to irradiate a sample with first incident light and acquire material property information of a constituent substance of the sample from Raman measurement data of the sample based on a scattered light image of scattered light scattered from the sample;
an ellipsometer configured to irradiate the sample with second incident light and acquire structural dimension information of the sample and optical constant information of the constituent substance from ellipsometer measurement data detected by a change in a polarization state of reflected light reflected from the sample; and
an artificial intelligence part configured to determine the optical constant information of the constituent substance by using one of a plurality of ellipsometer optical analysis models that use only the optical constant information of the constituent substance as a plotting variable according to a change in the material property information transmitted from the Raman device, or determine optimal structural dimension information of the sample by using one of a plurality of ellipsometer structural analysis models that use only the structural dimension information as a plotting parameter by selecting reference data of optical constants suitable for the constituent substance.

2. The fusion optical measurement device of claim 1, wherein the artificial intelligence part comprises a determination part configured to receive the ellipsometer measurement data transmitted from the ellipsometer, the structural dimension information, the optical constant information, the Raman measurement data transmitted from the Raman device, and the material property information, and determine whether there is the change in the material property information of the constituent substance.

3. The fusion optical measurement device of claim 2, wherein the artificial intelligence part comprises:
a structural dimension determination part configured to determine the structural dimension information using structural dimension measurement equipment when the determination part determines that there is the change in the material property information or when the material property information is received for a first time;
an optical constant fitting part configured to select one of the plurality of ellipsometer optical analysis models using the determined structural dimension information and then fit the selected one of the plurality of ellipsometer optical analysis models to the ellipsometer measurement data to determine the optical constant information;
a reference data storage part configured to store the optical constant information along with the material property information as reference data;
a selection part configured to select the reference data for the optical constants appropriate for the constituent substance based on the material property information transmitted from the determination part and select one of the plurality of ellipsometer structural analysis models;
a fitting part configured to determine the structural dimension information of the sample by fitting the structural dimension information transmitted from the selection part to the selected one of the plurality of ellipsometer structural analysis models; and
a big data part configured to store the Raman measurement data, the ellipsometer measurement data, the optical constant information, the material property information transmitted from the selection part, and the structural dimension information transmitted from the fitting part.

4. The fusion optical measurement device of claim 3, wherein the structural dimension information comprises a thin film layer thickness, nanopattern shape, interface layer thickness, and surface roughness of the sample, and
the optical constant information comprises a complex refractive index and complex dielectric constant of the sample, and
wherein the determination part is configured to select the optical constant information for one matched piece of the material property information when the material property information matches with one of measurement position-specific material property information of the sample, and
the fitting part is configured to use the optical constant information selected as reference information to select one of the plurality of ellipsometer structural analysis models, and then fit the selected one of the plurality of ellipsometer structural analysis models to the ellipsometer measurement data to determine the structural dimension information of the sample.

5. The fusion optical measurement device of claim 1, wherein the Raman device comprises:
a first light irradiation part configured to generate the first incident light by magnifying a magnitude of irradiation light after generating the irradiation light;
a beam splitter part arranged on a path of the first incident light, and configured to reflect the first incident light from the first light irradiation part toward the sample and transmit the scattered light from the sample;
a light collection part arranged in a same straight line as the sample and the beam splitter part, and configured to collect the first incident light reflected from the beam splitter part onto the sample;
a wavelength selective filter part arranged on a path of the scattered light and configured to selectively transmit Stokes scattered light and anti-Stokes scattered light among the scattered light transmitted from the beam splitter part;
a first detection part arranged on the path of the scattered light and configured to obtain a Stokes scattered light image and an anti-Stokes scattered light image from signals for the Stokes scattered light and the anti-Stokes scattered light selectively transmitted through the wavelength selective filter part; and
a first analysis part configured to analyze a temperature distribution of the sample based on the Stokes scattered light image and the anti-Stokes scattered light image transmitted from the first detection part, and analyze a composition distribution of the sample based on the Stokes scattered light image.

6. The fusion optical measurement device of claim 5, wherein the first analysis part is configured to analyze the temperature distribution of the sample based on a signal magnitude ratio of intensity of the Stokes scattered light and the intensity of the anti-Stokes scattered light obtained from the Stokes scattered light image and the anti-Stokes scattered light image selectively transmitted from the wavelength selective filter part.

7. The fusion optical measurement device of claim 5, wherein the first analysis part is configured to analyze the composition distribution of the sample by analyzing brightness of the Stokes scattered light image selectively transmitted from the wavelength selective filter part.

8. The fusion optical measurement device of claim 5, wherein the Raman device further comprises a polarization direction adjustment part that is arranged in the same straight line as the sample and the beam splitter part and configured to rotate to adjust a polarization direction of the first incident light reflected from the beam splitter part and a polarization direction of the scattered light.

9. The fusion optical measurement device of claim 8, wherein the first analysis part is configured to obtain a peak area where the signals of the scattered light image for each rotation angle in which the polarization direction of the scattered light is adjusted is a peak, and analyze a strain distribution for each position of the sample by superimposing the magnitude of the signals of the scattered light image for each rotation angle in which the polarization direction of the scattered light is adjusted on polar coordinates.

10. The fusion optical measurement device of claim 8, wherein the first light irradiation part comprises:
a first light source configured to generate the irradiation light and irradiate it toward the beam splitter part;
a line filter arranged on the path of the irradiation light and configured to transmit only the irradiation light having a first predetermined wavelength band among the irradiation light from the first light source; and
a magnifying lens arranged on the path of the irradiation light and configured to enlarge the magnitude of the irradiation light having the first predetermined wavelength band transmitted by the line filter to generate the first incident light.

11. The fusion optical measurement device of claim 8, wherein the beam splitter part is configured to reflect 10% to 30% of the first incident light from the first light irradiation part to the sample, and transmit 70% to 90% of the scattered light scattered from the sample.

12. The fusion optical measurement device of claim 1, the ellipsometer comprises:
a second light irradiation part configured to generate the second incident light and irradiate it to the sample;
a polarization generation part configured to polarize the second incident light transmitted from the second light irradiation part;
a polarization analysis part configured to polarize the reflected light reflected after the second incident light polarized by the polarization generation part is irradiated to the sample;
a second detection part configured to detect an electrical signal of the reflected light polarized by the polarization analysis part; and
a second analysis part configured to analyze the electrical signal of the reflected light detected by the second detection part to obtain the structural dimension information of the sample and the optical constant information of the constituent substance.
